(19) United States
(12) Patent Application Publication
(10) Pub. No.: US 2008/0024358 A1
(43) Pub. Date: Jan. 31, 2008

(54) Radar system

(75) Inventor: Hiroshi Ikeda, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/878,425

(22) Filed: Jul. 24, 2007

(30) Foreign Application Priority Data
Jul. 27, 2006 (JP) 2006-204650

(51) Int. Cl. G01S 13/00

(52) U.S. Cl. 342/200

(57) ABSTRACT

Provided is a radar system capable of appropriate detection even if a difference of a free space path loss due to a frequency in a range of occupied bandwidth is large. Based on a modulation signal, an amplitude control circuit amplifies amplitude of a modulated signal more significantly as the frequency in the occupied bandwidth is increased. Thus a transmission signal is generated such that the power is increased as the frequency is increased. The transmission signal is transmitted as a radio wave from the transmission antenna. As a result, a received signal obtained on the receiver side has a small level difference (i.e., having a frequency spectrum with a flat shape) between the high frequency signal components and low frequency signal components. Accurate detection is easily achieved based on the received signal.

### BACKGROUND OF THE INVENTION

1. Field of the Invention

The present invention relates to a radar system using a frequency-modulated signal as a transmission wave and used as a vehicle-mounted radar.

2. Description of the Related Art

In the related art, a vehicle-mounted radar has been known, for example, to measure the relative distance and relative velocity to an obstacle such as a preceding automobile or the like. There is provided a radar of Frequency Modulated-Continuous Wave (FMCW) method as this type of radar system. FMCW radar transmits a frequency modulated-continuous wave and receives the signal reflected by a detection target in order to synthesize it with the transmission signal thereby generating a beat signal. By analyzing the beat signal, FMCW radar detects the relative distance and relative velocity to the detection target. Other than that, there are provided a pulse method to transmit a pulse-modulated signal, and a method to transmit an amplitude-modulated signal and the like. Further, there is proposed a method to combine these methods. For example in Japanese Patent Publication No. 2003-255044, a method is proposed such that a transmission signal frequency-modulated is used when detecting a detection target in a far distance, and a transmission signal amplitude-modulated by a modulated wave far higher than that in the frequency-modulation is used when detecting a detection target in a short distance. Also in Japanese Patent Publication No. 2002-502042, a method is proposed such that an unmodulated signal is transmitted with high power when detecting a detection target in a far distance, and a frequency-modulated signal is transmitted with low power when detecting a detection target in a short distance.

### SUMMARY OF THE INVENTION

In recent years, Ultra Wide Band (UWB) with the occupied bandwidth of 500 MH_{z} or more has been taken notice. This is because the occupied bandwidth is wide in UWB but the level of signal components of each frequency is extremely small so that interference with other radio system can be reduced. On the other hand, the free space path loss of radio waves depends on frequency so that the signal loss is increased as the frequency is increased. Accordingly, in case of radio system with a wide bandwidth such as UWB, the level difference between the high-frequency signal components and low-frequency signal components of the received signal occurs according to propagation through the air, thereby accurate detection likely becomes difficult. In the standard of FMCW radar of the related art, for example, the deviation of frequency modulation is narrow as maximum 76 MH_{z} and the center frequency is set high frequency as 10 GH_{z} or 24 GH_{z}. Thus the ratio of the maximum frequency and minimum frequency in the occupied bandwidth is small so that the difference of the free space path loss due to a difference in frequency is not a problem. However, when UWB is applied to a FMCW radar, the ratio of the maximum frequency and minimum frequency in the occupied bandwidth becomes large so that the difference of the free space path loss due to a difference in frequency is also increased. Specifically, the difference of the free space path loss between the maximum frequency and minimum frequency reaches a couple of dB. As a result, distortion in the waveform occurs when the signal is processed on the receiver side, thereby accurate detection likely becomes difficult. In the radar system of the related art including Japanese Patent Publication No. 2003-255044 and Japanese Patent Publication No. 2002-502042, the circuit is configured without consideration of the free space path loss so that using them in a wide bandwidth as UWB causes a problem.

In view of the foregoing, it is desirable to provide a radar system capable of appropriate detection even if the difference of the free space path loss due to a difference in frequency is large in the occupied bandwidth.

According to an embodiment of the present invention, there is provided a radar system having a transmitter for transmitting a frequency-modulated signal and a receiver for receiving a signal reflected from a detection target to detect the detection target, including: a modulation signal generating circuit generating a modulation signal to be used in frequency modulation; an oscillator outputting a modulated signal produced through the frequency modulation based on the modulation signal; and a correction circuit correcting a difference of the free space path loss due to a difference in frequency, the free space path loss occurring when the modulated signal is transmitted and propagates through the air.

In the radar system according to an embodiment of the present invention, the correction circuit corrects the free space path loss due to a difference in frequency, the free space path loss occurring when the modulated signal is transmitted and propagates through the air. Thus an appropriate detection is achieved even if the difference of the free space path loss due to a difference in frequency is large.

Here, in the radar system according to an embodiment of the present invention, the correction circuit may have an amplitude control circuit provided in the transmitter, the amplitude control circuit configured to change an amplitude of the modulated signal according to the frequency based on the modulation signal.

In case of this configuration, based on the modulation signal, for example, the amplitude of the modulated signal is amplified more significantly as the frequency in the occupied bandwidth is increased. Also, the signal with larger power is outputted as a transmission signal as the frequency is increased. The free space path loss is increased as the frequency is increased. As a result, the received signal with a small difference in the frequency spectrum intensity (i.e., the frequency spectrum with flat shape) between the high frequency signal components and low frequency signal components can be obtained on the receiver side. Accurate detection is easily achieved based on the received signal.

In the radar system according to an embodiment of the present invention, the correction circuit may have a filter circuit provided in the transmitter or the receiver, the filter circuit having a filtering characteristic related to the difference of a free space path loss due to the difference in frequency, thereby filtering the modulated signal. In this case, the filter circuit, for example, may be composed of a high-pass filter having a cutoff frequency higher than a maximum frequency of an occupied bandwidth of the modulated signal and performing attenuation of a signal so that degree of the attenuation is increased as the frequency of the signal is decreased.

In this case, the filter circuit is provided on the transmitter side. Thus a signal as a transmission signal is outputted such that the amplitude of the modulated signal (i.e., the power) is increased as the frequency is relatively increased in the occupied bandwidth. The free space path loss is increased as the frequency is increased. As a result, a received signal can be obtained on the receiver side with a small level difference in the frequency spectrum intensity (i.e., the frequency spectrum with flat shape) between the high frequency signal components and low frequency signal components. Accurate detection is easily achieved based on the received signal.

Also, the filter circuit is provided on the receiver side. Thus even if a signal is received with a level difference between the high frequency signal components and low frequency signal components according to the free space path loss, the level difference is corrected in the filter circuit so that the signal with a small level difference in the frequency spectrum intensity (i.e., the frequency spectrum with flat shape) can be obtained. Accurate detection is easily achieved based on the received signal.

According to the radar system in an embodiment of the present invention, a difference of the free space path loss due to a difference in frequency, is corrected, the free space path loss occurring when the modulated signal is transmitted and propagates through the air. Thus appropriate detection is achieved even if the difference of the free space path loss due to a difference in frequency in the occupied bandwidth is large.

Other and further objects, features and advantages of the invention will appear more fully from the following description.

### BRIEF DESCRIPTION OF THE DRAWINGS

FIG. 1 is a block diagram showing a configuration example of a radar system according to a first embodiment of the present invention.

FIGS. 2A to 2C are diagrams showing signal waveforms on a transmitter side in the radar system according to the first embodiment of the present invention, while FIG. 2A is a waveform diagram of a modulation signal, FIG. 2B is a waveform diagram of a frequency-modulated signal, and FIG. 2C is a waveform diagram of a frequency-modulated signal after an amplitude is corrected.

FIG. 3 is an explanatory diagram showing an example of a frequency modulation signal spectrum.

FIG. 4 is an explanatory diagram showing a change of a spectrum according to a free space path loss.

FIG. 5 is an explanatory diagram showing a spectrum of frequency modulation signal after correction is made with consideration of the free space path loss.

FIG. 6 is a block diagram showing a configuration example of a radar system according to a second embodiment of the present invention.

FIG. 7 is a characteristic diagram showing an example of frequency characteristics of a filter used in the radar system according to the second embodiment of the present invention.

FIG. 8 is a block diagram showing a configuration example of the radar system according to a third embodiment of the present invention.

FIG. 9 is a waveform diagram showing another embodiment.

### DETAILED DESCRIPTION OF THE PREFERRED EMBODIMENTS

Below, preferred embodiments of the present invention are described in detail with reference to the accompanying drawings.

A first embodiment of the present invention is described.

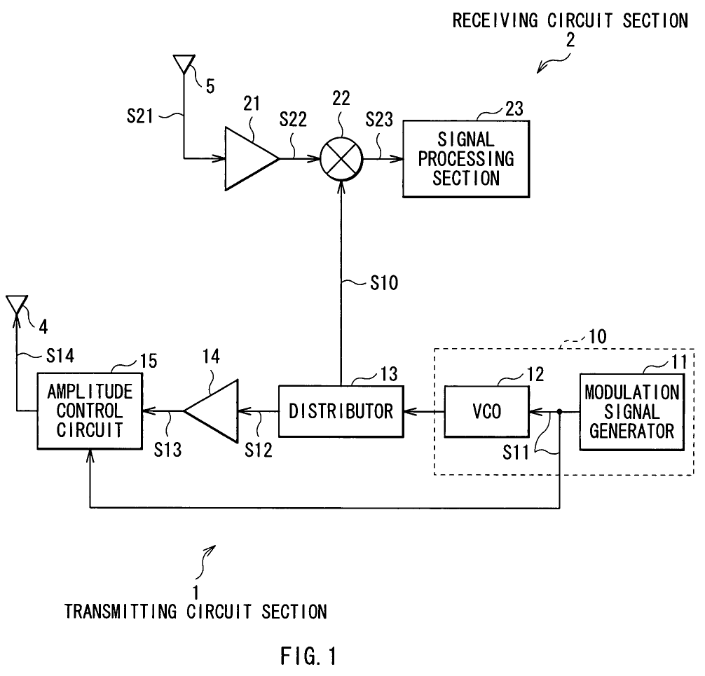

FIG. 1 shows a configuration example of a radar system according to the first embodiment. The radar system can be used, for example, as a vehicle-mounted radar. The radar system has a transmitting circuit section 1 to process transmitting and a receiving circuit section 2 to process receiving.

The transmitting circuit section 1 has a transmission antenna 4 to emit a transmission signal S14 as a radio wave, a frequency-modulated signal generating section 10 to generate the modulated signal of FMCW, and a distributor 13 to distribute a modulated signal outputted from the frequency-modulated signal generating section 10, to two signals S10 and S12. The transmitting circuit section 1 also has a transmitting amplifier 14 to amplify the modulated signal S12 of one of the distributed signals and an amplitude control circuit 15 to control the amplitude of an amplified modulated signal S13 and output it as a transmission signal S14. The frequency-modulated signal generating section 10 is composed of a modulation signal generator 11 to generate a modulation signal S11 used in the frequency modulation, and a Voltage Controlled Oscillator (VCO) 12 to output the modulated signal of FMCW which is frequency-modulated based on the modulation signal S11. When the modulated signal S13 is propagated as the transmission signal S14 through the air, the difference of the free space path loss due to a difference in frequency occurs. The amplitude control circuit 15 is to process correction of the difference and controls the amplitude of the modulated signal S13 based on the modulation signal S11 from the modulation signal generator 11.

In the present embodiment, the amplitude control circuit 15 corresponds to a specific example of a “correction circuit” of the present invention.

The receiving circuit section 2 has a receiving antenna 5 to receive a reflected wave reflected by a detection target (not shown in the figure) and then output it as the received signal S21, where the reflected wave is of the transmission signal S14 transmitted as a radio wave from the transmission antenna 4. The receiving circuit section 2 also has a receiving amplifier 21 to amplify the received signal S21 received at the receiving antenna 5. The receiving circuit section 2 further has a mixer 22 to generate a beat signal S23 by synthesizing the amplified received signal S22 and the modulated signal S10 of the other of the signals distributed by the distributor 13 in the transmitting circuit section 1, and a signal processing section 23 to analyze the beat signal S23 and then detect the relative distance and relative velocity of the detection target to the radar system. The signal processing section 23 has a Central Processing Unit (CPU) (not shown in the figure) that processes calculation to analyze the beat signal S23.

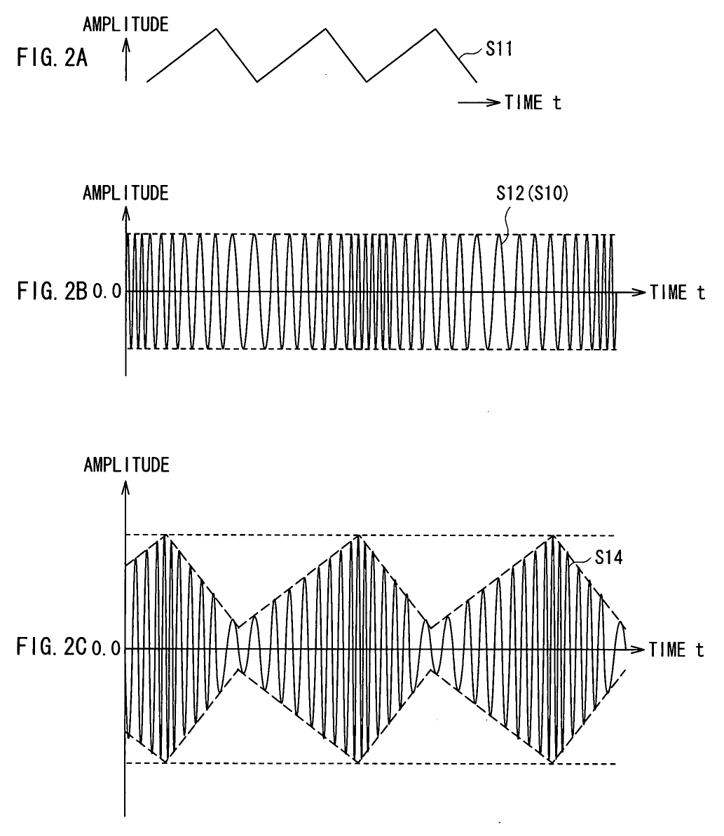

Next, operation of the radar system will be described. In the transmitting circuit section 1, the modulation signal generator 11 generates the modulation signal S11 such that the amplitude of the voltage is changed to have a triangle wave shape with time as in FIG. 2A, and applies it to the VCO 12. Based on the modulation signal S11, the VCO 12 generates the modulated signal of FMCW such that the frequency is changed with time as in FIG. 2B, and inputs it to the distributor 13. The modulated signal S12 of one of the signals distributed by the distributor 13 is amplified by the transmitting amplifier 14 and inputted to the amplitude control circuit 15. The modulated signal S10 of the other of the distributed signals is inputted to the mixer 22 of the receiving circuit section 2.

Based on the modulation signal S11 from the modulation signal generator 11, the amplitude control circuit 15 changes the amplitude of the modulated signal S13 according to the frequency. Thus, as in FIG. 2C, the transmitting signal S14 with an envelope waveform similar to the waveform of the modulation signal S11 is generated. The transmission antenna 4 emits the transmitting signal S14 as a radio wave to the detection target.

Here, the amplitude control by the amplitude circuit 15 is described as a specific example.

When FMCW is propagated as a transmission signal through the air, the free space path loss occurs and the amplitude control circuit 15 processes correction of the difference of the free space path loss due to a difference in frequency. The correction is effective in case of using FMCW with a wide occupied bandwidth. Specifically for example, the correction is effective in case of using FMCW with the wide occupied bandwidth such that the occupied bandwidth is 500 MH_{z} or more after being modulated in a wide band, or the condition of (f_{H}−f_{L})/(f_{H}+f_{L})≦0.2 is met. Here, f_{H} is the maximum frequency in the occupied bandwidth of FMCW and f_{L} is the minimum frequency in the occupied bandwidth of FMCW.

When a radio wave is emitted from the transmission antenna 4, the free space path loss (Pₐₜₕₗₒₛₛ) of the radio wave is expressed as:

Pₐₜₕₗₒₛₛ=20 log 10(4 πD/k)[dB] (1)

where D is a correspondence distance and λ is a wavelength.

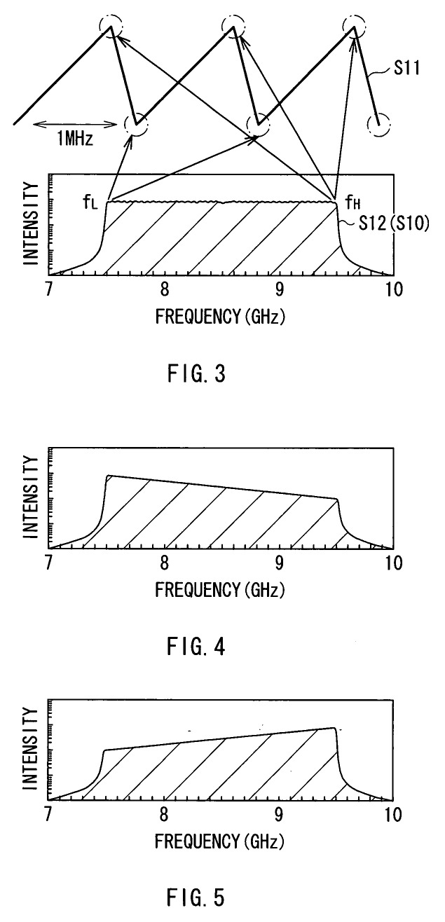

As a specific example, the modulation spectrum of the modulated signal S12 (S10) of FMCW is shown in FIG. 3. When the center frequency is 8.5 GH_{z}, the frequency deviation is 1 GH_{z}, and the maximum frequency of the modulation signal S11 is 1 MH_{z}, the occupied bandwidth (OBW) is expressed as:

OBW=2(f_{dev}+f_{mod})

where f_{dev} is the frequency deviation amount and f_{mod} is the maximum modulation frequency. Thus, OBW=approximately 2 GH_{z}, while the maximum spectrum value is 9.5 GH_{z} and the minimum spectrum value is 7.5 GH_{z}.

9.5 GH_{z} wavelength is 3.15 cm (=λ1), while 7.5 GH_{z} wavelength is 4 cm (=λ2). From the above equation (1), this ratio is regarded as the difference of the free space path loss between the maximum frequency and the minimum frequency in the occupied bandwidth. Specifically, the difference of the free space path loss is calculated as:

$$\begin{matrix}\begin{matrix}Difference \\ of the free \\ space path loss\end{matrix} = \vert \begin{matrix}- 20 log 10 ( 4 π D / λ 1 ) - \\ ( - 20 log 10 ( 4 π D / λ 2 )\end{matrix} \vert \\ = \vert - 20 log 10 ( ( 4 π D / λ 1 ) \cdot ( λ 2 / 4 π D ) ) \vert \\ = \vert - 20 log 10 ( λ 2 / λ 1 ) \vert \\ = \vert - 20 log 10 ( 0.04 / 0.0315 ) \vert \\ = Approximately 2 dB\end{matrix}$$

### The difference of the free space path loss between the maximum frequency and minimum frequency is approximately 1.5 times, meaning that on the receiver side, the power at 9.5 GH_{z} is only 70% or below of the power at 7.5 GH_{z}.

That is, as seen from the frequency spectrum, when FMCW with a flat signal waveform in the occupied bandwidth as in FIG. 3 is, as it is, transmitted as a radio wave, due to the free space path loss, the spectrum intensity on the receiver side is decreased as the frequency is increased as in FIG. 4. To correct distortion of the signal waveform, the output power is increased as the frequency is relatively increased and the output power is decreased as the frequency is relatively decreased.

In the present embodiment, based on the modulation signal S11, the amplitude control circuit 15 amplifies the amplitude of the modulated signal S13 more as the frequency in the occupied bandwidth is increased. Thus, the signal as the transmission signal S14 is generated such that the power is increased as the frequency is increased. Specifically, the shape of the envelope waveform is similar to the waveform of the modulation signal S11 as shown in FIG. 2C, and the signal is generated with the signal waveform such that the spectrum intensity is increased as the frequency is increased as shown in FIG. 5, as seen from the frequency spectrum. The free space path loss is increased as the frequency is increased. Thus the transmission signal S14 with the spectrum waveform as in FIG. 5 is transmitted as a radio wave from the transmission antenna 4 so that the received signal S21 can be obtained with a small level difference in the frequency spectrum intensity (i.e., the frequency spectrum with flat shape) between the high frequency signal components and the low frequency signal components on the receiver side. The receiving circuit section 2 can easily process accurate detection based on the received signal S21. Specifically, after the received signal S21 is amplified by the receiving amplifier 21, the amplified received signal S22 and the modulated signal S10 of the other of signals distributed by the distributor 13 in the transmitting circuit section 1 are synthesized at the mixer 22 to generate the beat signal S23. The signal processing section 23 analyzes the beat signal S23 to detect the relative distance and relative velocity of the detection target to the radar system.

As described above, according to the first embodiment, the amplitude of FMCW is changed according to the frequency based on the modulation signal S11 on the transmitter side. Thus, the difference of the free space path loss due to a difference in frequency is corrected, the free space path loss occurring when FMCW is transmitted and propagates through the air. Therefore appropriate detection is achieved even if the difference of the free space path loss due to a difference in frequency is large in the occupied bandwidth.

Next, a second embodiment is described. Same reference numerals as in the above first embodiment have been used to indicate substantially identical components, thereby some descriptions are appropriately omitted.

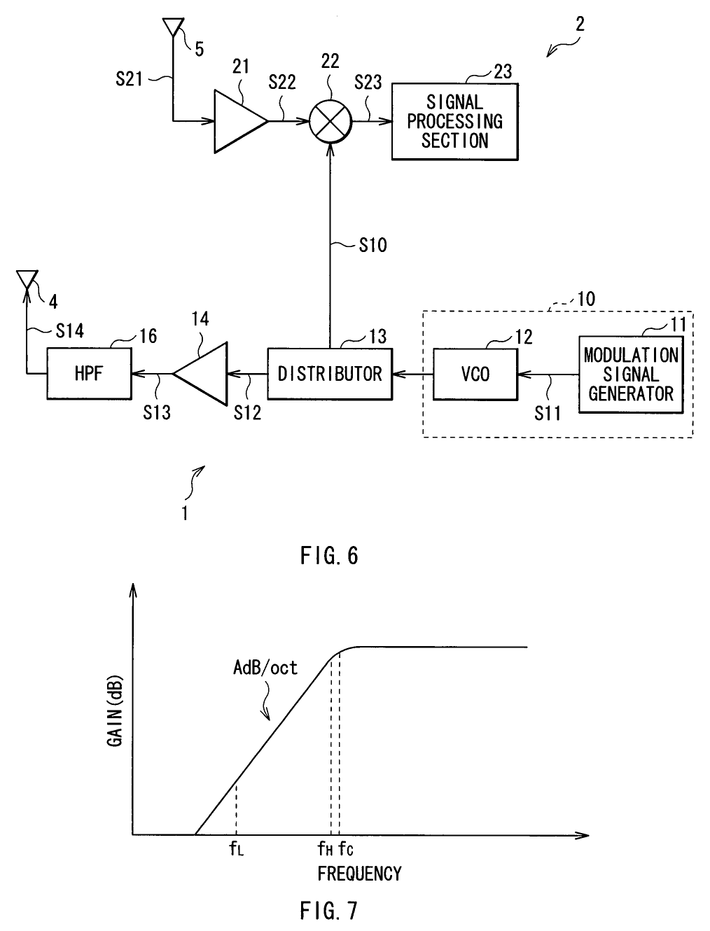

FIG. 6 shows a configuration example of a radar system according to the second embodiment. The radar system has a High Pass Filter (HPF) 16 in substitution of the amplitude control section 15 in the configuration of FIG. 1. In the second embodiment, the HPF 16 corresponds to a specific example of the “correction circuit” of the present invention.

The HPF 16 has filter characteristics according to the difference of the free space path loss due to a difference in frequency, and processes a predetermined filtering of the amplified modulated signal S13 on the transmitter side. For example as in FIG. 7, the HPF 16 is a filter having a linear filter characteristic that the cutoff frequency fc is higher than the maximum frequency f_{H} of the occupied bandwidth of the modulated signal S13 and attenuation of the signal is increased as the frequency is decreased. An attenuation slope A of the HPF 16 corresponds to the slope in the waveform of the modulation signal S11 as shown in FIG. 2A. For example, in case that the free space path loss is −20 log 10(λ2/λ1) as in the above specific example, the slope of the loss is −6 dB/oct, so that the attenuation slope A is set as 6 dB/oct to correct the slope of the loss.

In the second embodiment, the HPF 16 is provided on the transmitter side. Thus the signal is transmitted as the transmission signal S14 such that the amplitude of the modulated signal S13 (i.e., the power) is increased as the frequency in the occupied bandwidth is relatively increased. Specifically, as seen from the frequency spectrum, the signal is generated with a signal waveform such that the spectrum intensity is increased as the frequency is increased as in FIG. 5. The free space path loss is increased as the frequency is increased. Thus the transmission signal S14 with the spectrum waveform as in FIG. 5 is transmitted as a radio wave from the transmission antenna 4 so that the received signal S21 can be obtained with a small level difference in the frequency spectrum intensity (i.e., the frequency spectrum with flat shape) between the high frequency signal components and the low frequency signal components on the receiver side. The receiving circuit section 2 can easily process accurate detection based on the received signal S21.

Next, a third embodiment is described. Same reference numerals as in the above first and second embodiments have been used to indicate substantially identical components, thereby some descriptions are appropriately omitted.

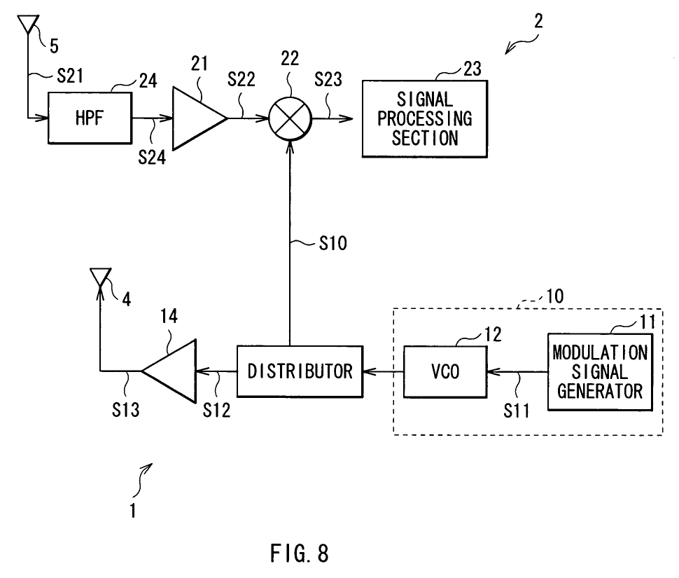

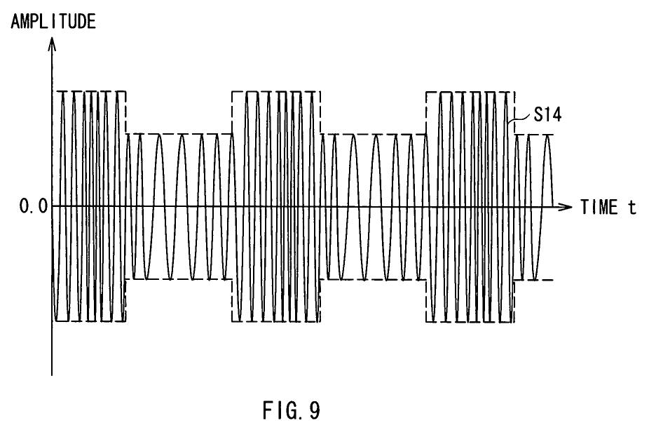

FIG. 8 shows a configuration example of a radar system according to the third embodiment. The radar system has a HPF 24 on the receiver side in substitution of the HPF 16 provided on the transmitter side in the second embodiment. The HPF 24 is provided between the receiving antenna 5 and the receiving amplifier 21 in the receiving circuit section 2. In the third embodiment, the HPF 24 corresponds to a specific example of the “correction circuit” of the present invention.

The HPF 24 has filter characteristics according to the difference of the free space path loss due to a difference in frequency, and processes a predetermined filtering of the received signal S21 on the receiver side. As in case of the HPF 16 in the second embodiment, the HPF 24 has a linear filter characteristic that the cutoff frequency fc is higher than the maximum frequency f_{H} of the occupied bandwidth of the modulated signal S13 as in FIG. 7 and attenuation of the signal is increased as the frequency is decreased.

In the third embodiment, the HPF 24 is provided on the receiver side. Thus even if the signal is received with a level difference between the high frequency signal components and the low frequency signal components according to the free space path loss, specifically as in FIG. 4, even if the signal is received as the received signal S21 such that the spectrum intensity is decreased as the frequency is increased, it is corrected by the HPF 24 so that the received signal S24 can be obtained with a small level difference in the frequency spectrum intensity (i.e., the frequency spectrum with flat shape). Accurate detection can be easily achieved based on the received signal S24.

The present invention is not limited to the above embodiments as various modifications are available. For example in the above embodiments, the amplitude modification or filtering process of a triangle wave shape similar to the modulation waveform is performed to the modulated signal. However, correction may be performed such that the envelope waveform is of step-shape as in FIG. 9. In FIG. 9, the amplitude level is corrected such that the envelope waveform has two levels, but may be corrected such that the envelope waveform has three levels or more. Also in this case, correction is processed as the amplitude of the modulated signal is increased as the frequency is relatively increased.

Obviously many modifications and variations of the present invention are possible in the light of the above teachings. It is therefore to be understood that within the scope of the appended claims the invention may be practiced otherwise than as specifically described.

What is claimed is:

1. A radar system having a transmitter for transmitting a frequency-modulated signal and a receiver for receiving a signal reflected from a detection target to detect the detection target, comprising:
a modulation signal generating circuit generating a modulation signal to be used in frequency modulation;
an oscillator outputting a modulated signal produced through the frequency modulation based on the modulation signal; and
a correction circuit correcting a difference of the free space path loss due to a difference in frequency, the free space path loss occurring when the modulated signal is transmitted and propagates through the air.

2. The radar system according to claim 1;
wherein the correction circuit includes an amplitude control circuit provided in the transmitter, the amplitude control circuit configured to change an amplitude of the modulated signal according to the frequency based on the modulation signal.

3. The radar system according to claim 1;
wherein the correction circuit includes a filter circuit provided in the transmitter or the receiver, the filter circuit having a filtering characteristic related to the difference of a free space path loss due to the difference in frequency, thereby filtering the modulated signal.

4. The radar system according to claim 3;
wherein the filter circuit is composed of a high-pass filter having a cutoff frequency higher than a maximum frequency of an occupied bandwidth of the modulated signal and performing attenuation of a signal so that degree of the attenuation is increased as the frequency of the signal is decreased.
